(19) United States
(12) Patent Application Publication
(10) Pub. No.: US 2009/0160861 A1
(43) Pub. Date: Jun. 25, 2009

(54) Spreadsheet In-Cell Range Graph Display Method

(76) Inventor: Kimiyasu Nakano, Iga-shi (JP)

Correspondence Address: OLIFF & BERRIDGE, PLC, P.O. BOX 320850, ALEXANDRIA, VA, 22320-4850, US

(21) Appl. No.: 11/992,288

(22) PCT Filed: Oct. 16, 2006
(86) PCT No.: PCT/JP2006/320553

§ 371 Date: Mar. 20, 2008

(30) Foreign Application Priority Data
Oct. 18, 2005 (JP) 2005-302978

(51) Int. Cl. G06T 11/20

(52) U.S. Cl. 345/440

(57) ABSTRACT

The present invention is developed for providing a method for displaying plural ranges in a spreadsheet in an easy-to understand manner by a simple operation. Based on range specification data entered in each of the plural cells, a zonal range graph displaying each range of the range specification data is displayed in a cell specified by a user. The color and/or pattern of each range may be different from each other in order to enhance the visual understandability. When a cell in which a range graph is displayed is resized, the range graph is also resized according to the new size of the cell. The range graph may be displayed in a longitudinal direction, if needed.

### TECHNICAL FIELD

Most spreadsheets (spreadsheet software) for accumulating and analyzing data have functions not only for computing but also for creating various kinds of graphs based on a plurality of data entered in cells. Such kinds of common graphs include a bar chart, line chart, pie chart, scatter diagram, etc. By using a proper kind of graph, the data that are not easily appreciated on their own can be visually expressed in an understandable manner.

Since the kinds of graphs which spreadsheets have as standard features are limited, not all data can be expressed in an optimum form of graph. Given this situation, various graphical display technologies have been developed and disclosed for visualizing the data of a spreadsheet in a more understandable form. Patent Document 1 discloses, for example, a technology for visualizing statistical data by dividing a rectangular figure into small areas whose size corresponds to a class value. The proper use of such graphical display technology allows a variety of data to be expressed in diverse forms.

However, any of the graph-drawing features as described earlier requires a point-by-point operation or setting for drawing a graph, which makes the operation troublesome. In addition, although it is necessary to place the created graph on a spreadsheet to be easily viewed, this is a considerably time-consuming operation in the case where the number of graphs is more than one.

In view of such circumstances, the inventor of the present invention studied in the light of visualizing a graph in a spreadsheet as simply and effectively as possible, and has achieved an invention in which a graph is displayed in a cell. The inventor has applied for a patent of this invention prior to the present invention (Patent Document 2).

Recently, Microsoft Corporation has released a feature for visually displaying a numerical value; a bar chart corresponding to the numerical value in a cell is displayed in the background of each cell in spreadsheet software (See Non-Patent Document 1).

[Patent document 1] Unexamined Japanese Patent Application Publication No. 2003-256855

[Patent document 2] Japanese Patent No. 3734491

[Non-Patent Document 1] “Trend”, Nikkei Personal Computing Nikkei Business Publications, Inc, Oct. 10, 2006. p. 16.

### DISCLOSURE OF THE INVENTION

### Problem to be Solved by the Invention

In the aforementioned spreadsheet in-cell graphical display method of Patent Document 2, based on data having a ratio value, a graph representing the ratio can be drawn in a designated cell to fit the size of the cell. In addition, based on range data, a graph representing the range can be drawn in a designated cell. The operation is tremendously simple and the layout of the created graphs can be done very easily.

The inventor of the present invention has dedicated himself to studying for further developing such a prominent invention as displaying a graph in a cell as described earlier. As a result, the inventor has come up with collectively displaying each of the ranges that plural range data show in one range graph.

### Means for Solving the Problem

The present invention made as described earlier provides an in-cell range graph display method for displaying a graph, on a computer system including at least a CPU (Central Processing Unit), a memory, a display unit, and an input unit, in a cell displayed on the display unit, wherein:

the CPU reads plural range specification data each composed of an upper limit value and a lower limit value entered in the same cell or different cells of a spreadsheet, creates a zonal range graph image as a range graph displaying each range of the plural range specification data, and displays the range graph in a predetermined cell.

In this description, “cell width” refers to the length of the long sides of a cell, that is, the length of the cell in the horizontal direction in general spreadsheets. “Cell thickness” refers to the length of the short sides of the cell, that is, the length of the cell in the vertical direction in general.

### EFFECT OF THE INVENTION

With the in-cell range graph display method according to the present invention, each range represented by a range specification data entered in each of the plural cells is displayed in one zonal graph, and the zonal graph is displayed in a specified cell. Therefore, the user can quickly know the range that each range data represents by comparing them at a glance. In addition, since the range graph is displayed in a cell, the time required for setting and layout is enormously reduced compared to the case where the graph is created with conventional features of spreadsheets.

### BRIEF DESCRIPTION OF THE DRAWINGS

FIG. 1 is a block diagram illustrating the configuration of a main portion of a computer system according to an embodiment of the present invention.

FIG. 2 illustrates an example of a configuration of range graph setting information.

FIG. 3 illustrates a flowchart of an in-cell range graph display processing program.

FIG. 4 illustrates a view displaying a range graph in a cell.

FIG. 5 illustrates a view when the cell is resized.

FIG. 6 illustrates an example where range specification data cells and a range graph display cell are specified with a function (upper portion), and a view displaying a range graph with an overlapping part (lower portion).

FIG. 7 illustrates another example of specifying range specification data cells and a range graph display cell

FIG. 8 illustrates a view of a range graph displayed in the longitudinal direction.

FIG. 9 illustrates a view in the case where a range graph specification cell and one of range specification data cells are the same cell.

### EXPLANATION OF NUMERALS

1 . . . Computer System
2 . . . CPU
3 . . . Memory
4 . . . Display Unit
5 . . . Input Unit
6 . . . Storage Unit

### BEST MODE FOR CARRYING OUT THE INVENTION

Hereinafter, embodiments of the present invention will be described referring to the figures.

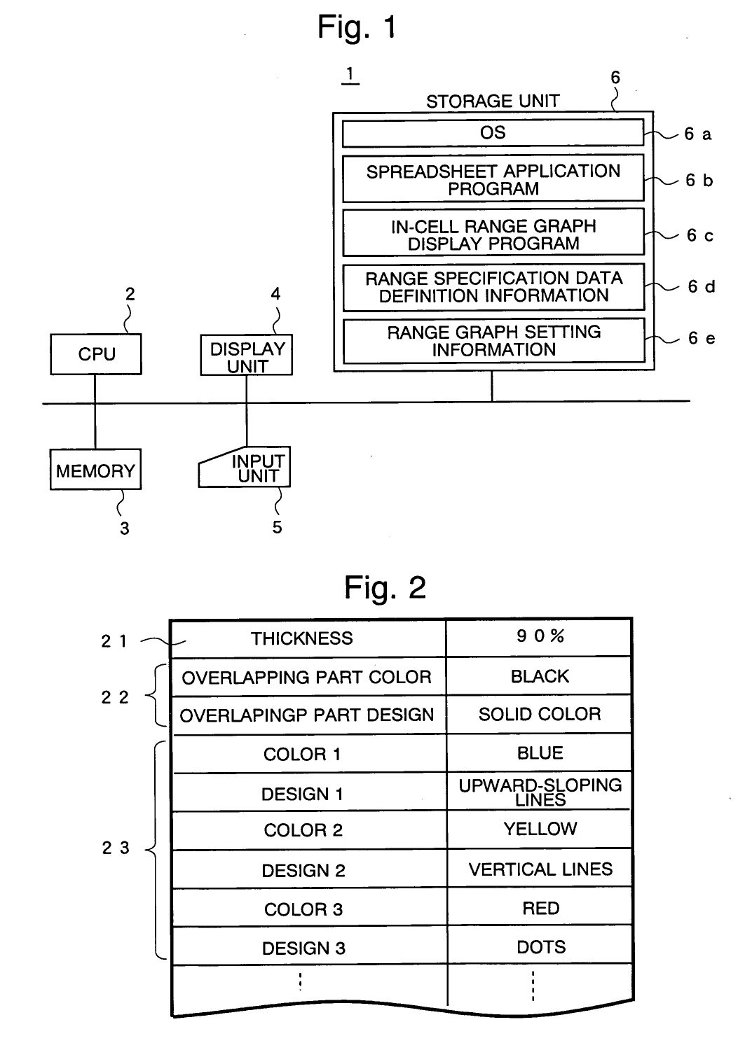

FIG. 1 is a block diagram illustrating the configuration of a main portion of a computer system 1 according to the present embodiment. The computer system 1 is configured so that a CPU 2, a memory 3, a display unit 4 formed of a CRT (Cathode Ray Tube) display or liquid crystal display, an input unit 5 formed of a keyboard having character and numeric keys and various functional keys and a mouse as a pointing device, and a storage unit 6 are interconnected. The storage unit 6 has a storage medium such as a magnetic recording medium, an optical recording medium or a semiconductor memory, which pre-stores programs and data therein. The storage medium may be fixed to the storage unit 6 or detachably provided. The storage unit 6 stores an OS (Operating System) 6a, a spreadsheet application program 6b, an in-cell range graph display program 6c, range specification data definition information 6d and range graph setting information 6e therein.

The in-cell range graph display program 6c according to the present invention can be implemented as a macro or may be built on as a type of a function (upper portion of FIG. 6) in various spreadsheet application programs. It can be applied not only to spreadsheet applications but also to various application programs having a spreadsheet feature.

The range specification data definition information 6d is a table for defining the format of a range specification data composed of an upper limit value and a lower limit value. The in-cell range graph display program 6c refers to the range specification data definition information 6d to extract an upper limit value and a lower limit value included in a range specification data. The format of a range specification data is not specifically limited; it may be described, for example, with various bound symbols such as a comma “2,6” and a colon “2:6.” The format may be described as a function such as “range(2,6),” or may be described with the combination of predetermined letters such as “upper limit 2 lower limit 6.”

The upper limit value and the lower limit value described by a range specification data may not only be figures, but may be a time period described with dates or times.

The range specification data may not necessarily be entered in one cell in the present invention. The range specification data may be composed of the combination of a cell in which a lower limit value is entered and a cell in which an upper limit value is entered.

A configuration example of the range graph setting information 6e is illustrated in FIG. 2. In the range graph setting information 6e, as shown below, display format information on a display format, which is required for creating a range graph image, and layout information for placing a range graph image are recorded:

thickness information 21 of a range graph,

overlapping part information 22 for specifying the color and the pattern of the overlapping part in which the ranges of range specification data are overlapped, and

color information 23 for specifying the color and the pattern of each range.

The data included in the range graph setting information 6e can be freely changed through the input unit 5.

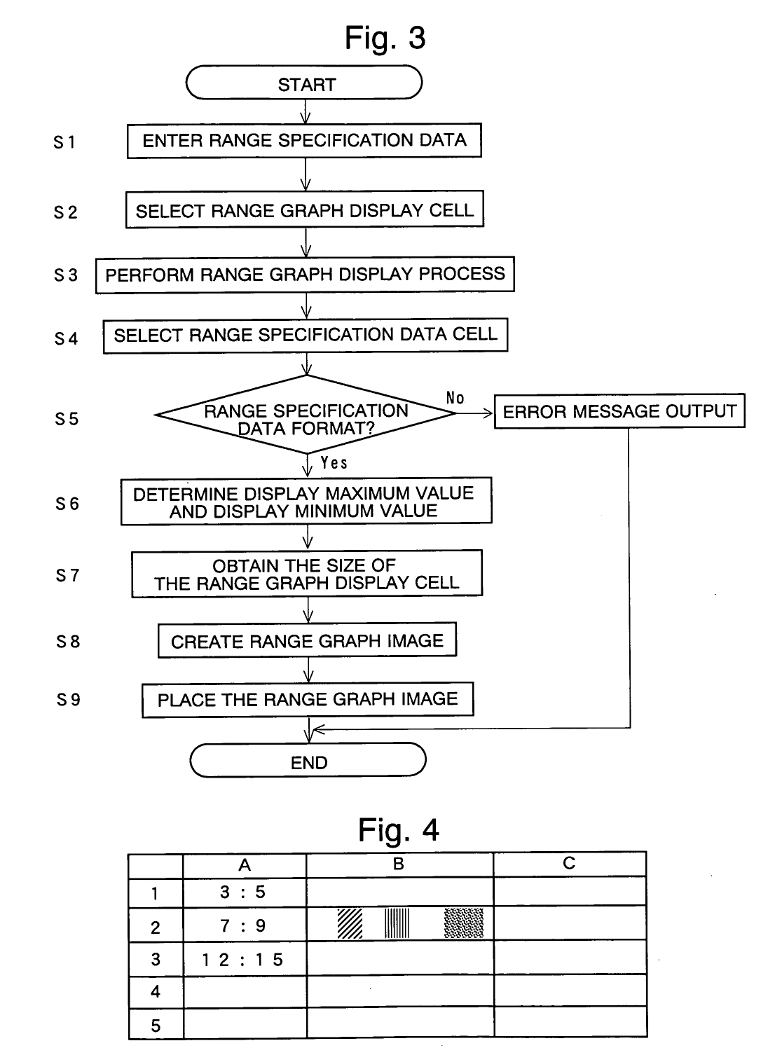

Next, an in-cell range graph display process which is performed by the CPU 2 executing the in-cell range graph display program (abbreviated as “program” hereinafter) will be explained referring to the flowchart illustrated in FIG. 3.

First, the user operates the input unit 5 to enter range specification data in any plural cells (called “range specification data cell” hereinafter) in a spreadsheet (Step S1). Here, as illustrated in FIG. 4, “3:5”, “7:9”, and “12:15” as range specification data are respectively entered in Cells A1, A2, and A3 in the spreadsheet.

The range specification data may be manually entered by the user or may be automatically entered in cells as a result of a predetermined calculation process.

Next, the user selects a cell (called “range graph display cell” hereinafter) in which a range graph is to be displayed by the input unit 5 (Step S2). Here, Cell B2 is selected. Then, the user directs the execution of the in-cell range graph display process by an input via the input unit 5 (Step S3).

When the user selects the range specification data cells (Cells A1, A2, and A3) in Step S4, the program confirms if the range specification data comply with the data format defined in the range specification data definition information 6d (Step S5).

The selection of range specification data cells and a range graph display cell can be performed in any method in the present invention. For example, a dialog box (not shown) may be displayed for allowing the user to select the range specification data cells and the range graph display cell according to the direction.

As a result of the data format's confirmation in Step S5, in the case where the format is not defined, a predetermined error message is displayed to finish the in-cell range graph display process.

If the format is defined, the operation proceeds to Step S6 to determine the display maximum value and the display minimum value. The display maximum value and the display minimum value are the maximum value and the minimum value which are the values for both ends of a range graph. In the example illustrated in FIG. 4, a range graph which is composed of three ranges as 3-5, 7-9, and 12-15 (each of these ranges are respectively called the first range, the second range, and the third range) is drawn. Although the minimum value of the whole range specification data is 3 and the maximum value is 15, the display minimum value is set to 0 and the display maximum value is set to 16.

The display maximum value and the display minimum value may be predetermined values or may be determined based on the minimum value and the maximum value of the whole range specification data. For example, the values obtained by adding the value of a predetermined ratio of the difference between the minimum value and the maximum value back and forth may be respectively the display minimum value and the display maximum value.

Proper setting of the display maximum value and the display minimum value makes a range graph more easily viewable.

Subsequently, the program acquires the size of the range graph display cell. Specifically, it acquires the values of the width and the thickness of the range graph display cell (Step S7). In the present embodiment, the values of width and thickness are 320 pixels and 20 pixels, respectively.

Next, the program creates a range graph image (Step S8). The range graph image is a zonal graph displaying each range of the plural range specification data. In the present invention, a range graph image having the same size as that of the range graph display cell may be created and it may be displayed in the range graph display cell. Alternatively, images for each range may be separately created and the images for each range on predetermined positions are placed in the range graph display cell to make a zonal graph, which is a range graph image.

In the case where a range graph image having the same size as that of a range graph display cell is created in Step S8, each range's width is computed based on the size of the cell obtained in Step S7 and the display maximum value and the display maximum value determined in Step S6. The thickness is computed based on the thickness information 21 described in the range graph setting information 6e. In addition, the color and the pattern are set according to the color information 23. Accordingly, a range graph image is created.

In the example illustrated in FIG. 4, the display minimum value is 0 and the display maximum value is 16. Therefore, the first range is drawn on (320/16)×3−(320/16)×5, i.e. 60-100 pixels from the left end of the range graph image. The thickness is 20×90%=18 pixels. The pattern of the first range is upward-sloping lines, and the color is blue. The same processes are performed as for the second range and the third range.

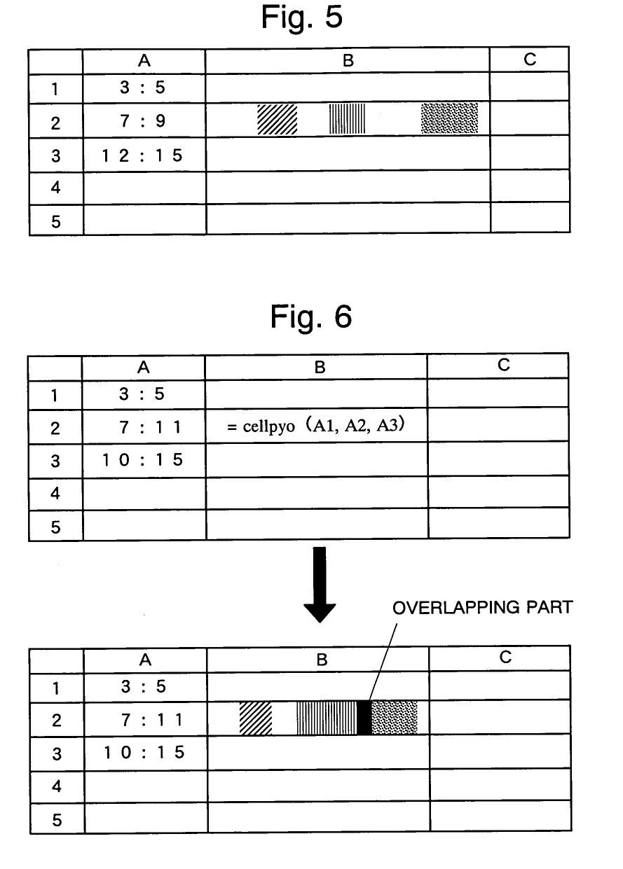

After that, in Step S9, the program places the image of the range graph in the range graph display cell and shows it on the display device used as the display unit 4 (FIG. 5). Then the process is consequently finished.

As described thus far, plural range graphs are displayed as a single zonal graph in a cell of a spreadsheet. Therefore, the plural range data are visualized in an easy-to understand manner.

In most spreadsheets, cells can be freely resized. Therefore, in the case where the range graph display cell is resized, in order for the range graph to always correspond to the size of the new range graph display cell (FIG. 5), the aforementioned processes of Steps S7 through S9 may be preferably executed again.

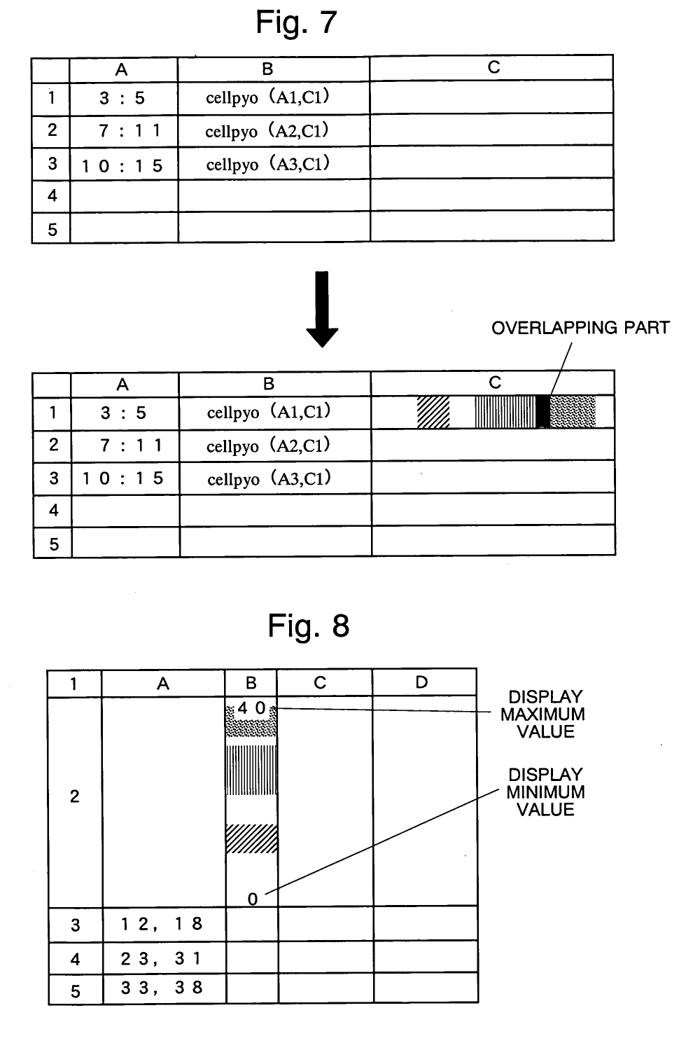

In some cases, each data of plural range specification data overlaps each other. In this case, the range graph image is created so that the overlap range is displayed based on the overlapping part information 22 in the range graph setting information 6e. In FIGS. 6 and 7, the ranges specified in Cells A2 and A3 partially overlap each other (at a range of 10-11). The overlapping part is drawn in a user-friendly manner (according to the description in the overlapping part information 22).

Although the selection method for range specification data cells and a range graph display cell may be any such means, as mentioned earlier, it can be entered as a function in order to further increase the user-friendliness. In this case, when a predetermined function is entered, the program is dynamically executed. The upper portion of FIG. 6 illustrates an example in which a function “=cellpyo(A1, A2, A3)” is entered in Cell B2 for displaying a range specification graph. Based on this input, the program reads the range specification data described in Cells A1, A2, and A3, and then performs the processes from Step S5 in the flowchart of FIG. 3. As a consequence, as illustrated in the lower portion of FIG. 6, a range specification graph is displayed in Cell B2.

As another example of selecting range specification data cells and a range graph display cell, as illustrated in the upper portion of FIG. 7, a range specification data cell and a range graph display cell may be described as arguments. In the example illustrated in the upper portion of FIG. 7, a character string of “cellpyo(A1, C1)” is described in Cell B1, specifying Cell A1 as a range specification data cell and Cell C1 as a range graph display cell. At the same time, in Cells B2 and B3, character strings are entered for specifying each of Cells A2 and A3 as range specification data cell and specifying Cell C1 as a range graph display cell.

In ordinary spreadsheets, when a character string beginning with “=” (an equal sign) is entered in a cell, an intrinsic function is automatically called and executed. Therefore, in the present example in which a range specification data cell and a range graph display cell are specified by the data described in plural cells, it is preferable to use character strings with a format not describing an equal sign in the first letter.

After that, when the user executes the program by operating the input unit 5, the program refers to the character strings entered in Cells B1, B2, and B3 and reads the range specification data described in Cells A1, A2, and A3. Then the program performs the processes from Step S5 in the flowchart of FIG. 3, and displays a range specification graph in Cell C1 (lower portion of FIG. 7).

In some usages of a spreadsheet, the vertical direction of a cell may be the long sides. In order to deal with this case, it may preferably be capable of creating a range graph showing the ranges in a vertical direction of a cell by regarding the vertical direction as a width of a cell and the horizontal direction as a thickness of the cell as illustrated in FIG. 8 (Cell B2 of FIG. 8).

It may be possible to include a display minimum value and a display maximum value in a range graph image, so that the user can understand the meaning of the range graph more quickly when he or she looks at it (FIG. 8). In the example illustrated in FIG. 8, both values of the display minimum value 0 and the display maximum value 40 which are previously set are displayed at both ends of the range graph image (i.e. both ends of the range graph display cell).

In another preferable embodiment of the present invention, it is possible to provide a scale based on the display minimum value and the display maximum value. For example, a scale image may be created and the scale image may be located in a cell designated as a scale display cell. By providing the scale, when the user refers to the range graph, he or she can further easily recognize the range represented thereby.

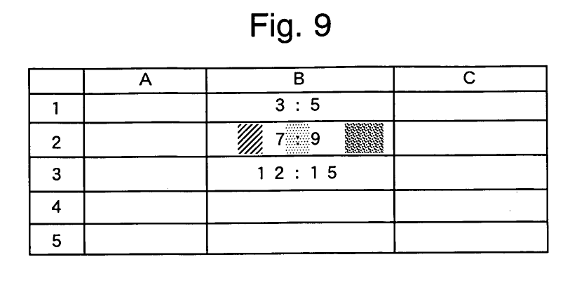

In yet another embodiment of the present invention, the range graph display cell and any of the plural range specification data cells may be the same (FIG. 9). In the example of FIG. 9, Cell B2, which is one of the range specification data cells, is also a range graph display cell. In this case, in order to ensure visibility of both the letters of the range specification data and the range graph which is the background, the brightness of the range graph image may preferably be high enough for the letters of the range specification data to be legible.

As described thus far, the in-cell range graph display method according to the present invention has been explained. It should be noted that any modification and adjustment properly made within the spirit of the present invention is also covered within the scope of the claims of the present invention.

1. An in-cell range graph display method for displaying a graph, on a computer system including at least a CPU (Central Processing Unit), a memory, a display unit, and an input unit, in a cell displayed on the display unit, wherein:
the CPU reads plural range specification data each composed of an upper limit value and a lower limit value entered in a same cell or different cells of a spreadsheet, creates a zonal range graph image as a range graph displaying each range of the plural range specification data, and displays the range graph in a predetermined cell.

2. The in-cell range graph display method according to claim 1, wherein a display minimum value and a display maximum value of the range graph are predetermined or are determined based on a minimum value and a maximum value of the whole plural range specification data.

3. The in-cell range graph display method according to claim 1, wherein a color or/and a pattern of each range of the range graph is different from each other.

4. The in-cell range graph display method according to claim 1, wherein, when the cell in which a range graph is displayed is resized, a display of the range graph is changed to display the range according to a new cell size.

5. The in-cell range graph display method according to claim 1, wherein, a cell in which a range graph is displayed and any one of plural cells in which a range specification data is entered are a same.

6. An in-cell range graph display program executed on a computer system including at least a CPU, a memory, a display unit, and an input unit, for displaying a graph in a cell displayed on the display unit, comprising the steps of:
reading plural range specification data each comprising an upper limit value and a lower limit value entered in a same cell or different cells of a spreadsheet;
setting a display minimum value and a display maximum value based on a predetermined value or are determined based on a minimum value and a maximum value of the whole plural range specification data; and
regarding the display minimum value and the display maximum value as values for both ends of one predetermined cell and displaying one zonal range graph displaying each of the ranges in the cell.

7. The in-cell range graph display method according to claim 2, wherein a color or/and a pattern of each range of the range graph is different from each other.

8. The in-cell range graph display method according to claim 2, wherein, when the cell in which a range graph is displayed is resized, a display of the range graph is changed to display the range according to a new cell size.

9. The in-cell range graph display method according to claim 3, wherein, when the cell in which a range graph is displayed is resized, a display of the range graph is changed to display the range according to a new cell size.

10. The in-cell range graph display method according to claim 2, wherein, a cell in which a range graph is displayed and any one of plural cells in which a range specification data is entered are a same.

11. The in-cell range graph display method according to claim 3, wherein, a cell in which a range graph is displayed and any one of plural cells in which a range specification data is entered are a same.

12. The in-cell range graph display method according to claim 4, wherein, a cell in which a range graph is displayed and any one of plural cells in which a range specification data is entered are a same.
